(19) United States
(12) Patent Application Publication
(10) Pub. No.: US 2026/0160335 A1
(43) Pub. Date: Jun. 11, 2026

(54) PUMP DEVICE COMPRISING A SCREW PLUG

(71) Applicant: FRIDECO AG, Neunkirch (CH)

(72) Inventors: Dieter BRÜHLMANN, Neunkirch (CH); Andreas Bruno WÜRMS, Gächlingen (CH)

(21) Appl. No.: 18/704,614

(22) PCT Filed: Jun. 15, 2022
(86) PCT No.: PCT/EP2022/066382

§ 371 Date: Apr. 25, 2024

(30) Foreign Application Priority Data
Oct. 27, 2021 (DE) 20 2021 105 881.1

(51) Int. Cl. F16J 15/10

(52) U.S. Cl. CPC F16J 15/106

(57) ABSTRACT

A pump device comprises a screw plug which has a threaded element and a base body that is connected to the threaded element, and has a sealing element receptacle, which circulates in the circumferential direction, for a sealing element,
wherein, at least when viewed radially, a tolerance compensation unit is arranged between the threaded element and the sealing element receptacle.

### PRIOR ART

The invention relates to a pump device according to the preamble of claim 1.

Hexagon socket screw plugs, as are described, for example, in the German standards DIN 906 or DIN 908, are already known from the prior art. Hexagon head screw plugs, as described, for example, in the German standard DIN 910, are also known.

It is the object of the invention in particular to provide a pump device of the type in question with improved properties in respect of design, in particular with regard to sealing. The objective is achieved according to the invention by the features of claim 1, while advantageous implementations and further developments of the invention can be gathered from the dependent claims.

### Advantages of the Invention

The invention is based on a pump device comprising a screw plug which has a threaded element and a base body that is connected to the threaded element, and has a sealing element receptacle, which circulates in the circumferential direction, for a sealing element.

It is proposed that, at least when viewed radially, a tolerance compensation unit is arranged between the threaded element and the sealing element receptacle. A refinement of this type makes it possible to provide an improved design and advantageously to increase efficiency. The efficiency can be increased preferably in respect of product and/or work input and/or production and/or cost efficiency. In addition, sealing of a pump device can be improved by means of such a sealing receptacle for a sealing element, and a secure closure of a recess of a pump component of the pump device by means of a screw plug can be provided. This can also improve comfort, in particular ease of installation and/or production. Furthermore, owing to a tolerance compensation unit, tolerances, in particular manufacturing tolerances, specifically deviations in a material thickness of the screw plug and/or of the pump component, in particular of the recess into which the screw plug can be screwed and/or from which it can be unscrewed, are compensated and an outlay, in particular a production and/or installation outlay, is thus reduced and costs, in respect of material and/or installation and/or production costs, are lowered. By means of the tolerance compensation unit, advantageously complete sealing can be provided when the screw plug is screwed into the recess, even if the recess, in particular a chamfer of a threaded hole of the recess, has been made too large. Furthermore, the screw plug, in particular with the sealing element, is preferably usable multiple times.

A “pump device” is intended to be understood as meaning a component, in particular a functional component, in particular a construction and/or functional component, of a pump. In particular, the pump device could comprise the entire pump.

In particular, the screw plug has the tolerance compensation unit. The tolerance compensation unit is preferably connected to the base body, in particular in one piece. Preferably, the tolerance compensation unit is formed integrally with the base body. The fact that at least one first element is “connected” to at least one other element is intended to be understood as meaning that the first element is advantageously connected to the further element via at least one force-fitting connection and/or at least one form-fitting connection, for example by riveting and/or by a latching connection and/or a tongue and groove connection and/or a clamping connection and/or another connection appearing expedient to a person skilled in the art. Alternatively and/or additionally, the element can be connected to the other element in an integrally bonded manner, for example by a welding process, a gluing process, an injection molding process and/or another process appearing expedient to a person skilled in the art. The term “in one piece” is intended to be understood as meaning connected at least in an integrally bonded manner, for example by a welding process, a gluing process, an injection molding process and/or another process appearing expedient to a person skilled in the art, and/or advantageously formed in one piece, for example by production from a casting and/or by production in a single- or multi-component injection molding process and advantageously from a single blank. Advantageously, in one piece should also be understood as meaning integrally. The term “integrally” should be understood as meaning formed in one piece. Preferably, this one piece is produced from a single blank, a mass and/or a casting, particularly preferably in an injection molding process, in particular a single- and/or multi-component injection molding process.

In particular, the pump device has the sealing element. The sealing element may possibly also be part of the screw plug. The sealing element can be, for example, a flat seal and/or a ring seal, advantageously an O-ring seal. In particular, the sealing element corresponds at least substantially to the implementation described in the standard ISO 3601. The sealing element could be at least partially or to a large extent or completely formed from a plastic and/or a rubber, for example FKM, NBR, EPDM and/or FFKM, and/or a composite material. For example, the term “to a large extent” is intended to be understood as meaning at least 55%, advantageously at least 65%, preferably at least 75%, particularly preferably at least 85% and particularly advantageously at most 99% of a volume and/or mass portion. The sealing element receptacle can be designed as a groove circulating in the base body in the circumferential direction. Advantageously, the sealing receptacle forms an O-ring sealing element receptacle. The sealing element can be interchangeable. The sealing element is insertable in particular reversibly into the sealing receptacle. In this context, “at least substantially” is intended to be understood as meaning that a deviation from a predetermined value deviates from the predetermined value in particular by less than 25%, preferably less than 10% and particularly preferably less than 5%.

The screw plug can be at least partially or to a large extent or completely formed from a mineral and/or a plastic and/or a metal, advantageously from a rust-free material, preferably from rust-free A4 stainless steel, in particular A4-70 stainless steel, and/or a composite material.

“Configured” is intended to be understood as meaning specially programmed, designed and/or equipped. The fact that an object is configured for a particular function is intended to be understood as meaning in particular that the object fulfills and/or carries out this particular function in at least one application state and/or operation state.

It is further proposed that the tolerance compensation unit is realized as a portion of the base body and at least partially delimits the sealing element receptacle. In particular, the tolerance compensation unit is formed integrally with the base body. For example, the tolerance compensation unit could delimit the sealing element receptacle at least with respect to a surface circulating in the circumferential direction, in particular with respect to at least two surfaces circulating in the circumferential direction. Preferably, the tolerance compensation unit delimits the sealing element receptacle at least in the direction of a screw axis of the screw plug. In particular, the tolerance compensation unit provides a stop for the sealing element. A refinement of this type makes it possible to achieve an improved design and to increase efficiency. In addition, the sealing element receptacle can thus receive the sealing element particularly advantageously and the sealing element can be mounted in the sealing receptacle in a particularly stable position. As a result, product and/or labor and/or production and/or cost efficiency can be increased and a production and/or installation outlay reduced.

In order to further improve a design, it is proposed that the tolerance compensation unit extends circumferentially around the threaded element at least substantially perpendicularly to the threaded element. In particular, the tolerance compensation unit has a rotationally symmetrical geometry. Preferably, the tolerance compensation unit has an at least substantially circular cross section. In this context, “at least substantially” is intended to be understood as meaning that a deviation from a predetermined value deviates from the predetermined value in particular by less than 25%, preferably less than 10% and particularly preferably less than 5%. This provides particularly efficient compensation of tolerances. In addition, production and/or installation costs can be reduced and costs, in respect of material and/or installation and/or production costs, can be lowered. In addition, particularly advantageous seal tightness can be achieved by means of a sealing element. In addition, a circumferentially full-surface stop can be provided for the sealing element.

It is also proposed that the threaded element has a standard external thread. In particular, the standard external thread is realized as a standardized external thread. For example, the threaded element could have a tapered pipe thread or a metric fine thread. Preferably, but not limited thereto, the threaded element could have a cylindrical Whitworth pipe thread according to DIN 259. It would be conceivable for the screw plug to be compatible with screw plugs according to DIN 908, DIN 910 and/or VSTI. Such an implementation can advantageously achieve particularly high compatibility and a design can be further improved. Furthermore, a high degree of flexibility, in particular in respect of a use purpose of a screw plug, can be made possible by such an implementation.

Furthermore, it is proposed that an inner diameter of the sealing element receptacle is substantially larger than a nominal diameter of the threaded element. In particular, the nominal diameter of the threaded element is a nominal diameter of the standard thread of the threaded element. The inner diameter of the sealing element receptacle is in particular a maximally inscribed circle through the sealing element receptacle. Preferably, the inner diameter is an inner diameter of the O-ring sealing element receptacle. The term that the inner diameter of the sealing element receptacle “is substantially larger” than a nominal diameter of the threaded element is intended to be understood as meaning in this context that the inner diameter of the sealing element receptacle is at least 3%, advantageously at least 5%, preferably at least 6% and particularly preferably at most 10% larger than a nominal diameter of the threaded element. Preferably, the inner diameter of the sealing element receptacle, in particular the O-ring sealing element receptacle, is dependent on a nominal size of the screw plug, in particular the nominal diameter of the threaded element. For example, the inner diameter of the sealing receptacle may be at least 0.5 mm or at least 1 mm or at least 2 mm larger than the nominal diameter of the threaded element. This enables a particularly advantageous design with improved properties, specifically in respect of sealing, to be provided. Thus, any disadvantages leading to an unstable and leaky connection of a screw plug with a pump component of a pump device can be minimized and preferably eliminated. By means of such a dependency of an inner diameter of a sealing element receptacle on a nominal diameter of a threaded element, optimal sealing can be provided, wherein a sealing element, which is in an inserted state in the sealing element receptacle, provides the preferred sealing, even if a recess, in particular a chamfer of a threaded hole of the recess, has been made too large. In addition, advantageous properties in respect of compensation of tolerances can be achieved.

Furthermore, it is proposed that an outer diameter of the base body is substantially larger than an outer diameter of the sealing element receptacle. In particular, the outer diameter of the base body corresponds to a minimum circle inscribed by the base body. For example, the outer diameter of the base body is at least 0.5 mm or at least 1 mm larger than the outer diameter of the sealing element receptacle. In particular, if the standard thread comprises at least a size of a G1-inch pipe thread, the outer diameter of the base body is at least 2 mm larger than the outer diameter of the sealing element receptacle. This allows a design to be further improved and an advantageous stability to be achieved. In addition, particularly efficient sealing of the design can be provided.

In addition, it is proposed that the base body has an outer region which, when viewed radially, is arranged outside the sealing element receptacle and at least partially delimits the sealing element receptacle. For example, the outer region could delimit the sealing element receptacle at least with respect to a surface circulating in the circumferential direction, in particular with respect to at least two surfaces circulating in the circumferential direction. The outer surface could delimit the sealing element receptacle at least with respect to a surface which circulates in the circumferential direction and is arranged lying opposite the tolerance compensation unit. Advantageously, the sealing element receptacle, in particular in a cross-sectional view along the screw axis of the screw plug, is arranged between the tolerance compensation unit and the outer region. Preferably, the outer region delimits the sealing element receptacle at least in a direction facing away from the screw axis of the screw plug. In particular, the outer region provides a stop for the sealing element. In particular, the outer region is an external volume region of the base body. The outer region is at, in particular, a larger radial distance from the screw axis than the tolerance compensation unit and in particular than the sealing element receptacle. A refinement of this type makes it possible to achieve an improved design. Furthermore, a sealing element receptacle can thus receive a sealing element particularly advantageously, the sealing element being able to be mounted in a particularly stable position in the sealing element receptacle.

In order to further improve a design and to increase efficiency, it is proposed that the pump device has a pump component with a recess, in particular with a service connection, which connects at least one first spatial region to at least one second spatial region fluid-technically and/or gas-technically, wherein the recess for fluid-tight and/or gas-tight sealing of the first spatial region against the second spatial region is configured for receiving at least the screw plug. In particular, the recess of the pump component is realized as a service connection which, for example, but not limited thereto, at least allows a fluid change, cleaning and/or maintenance of at least one pump component. Alternatively and/or additionally, the screw plug can be configured for sealing gases, such as air. For example, the first spatial region could be designed as a first functional space of the pump. It would also be conceivable for the first spatial region to be an environment of the pump, in particular of the pump component, wherein the screw plug seals the second spatial region of the pump, designed for example as a functional space, from the environment of the pump. Thus, a recess of a pump component can be closed and preferably completely sealed by means of a screw plug.

In a further implementation of the invention, it is proposed that the pump component has a contact surface for the sealing element, and the recess has an internal threaded region for the threaded element and has a chamfer which connects the contact surface to the internal threaded region. This can further improve the design and increase efficiency, specifically in respect of product and/or labor and/or production and/or installation and/or removal efficiency. Furthermore, simple, quick and practical installation and/or removal can be provided, and therefore an outlay, in particular an installation and/or removal outlay, can be reduced. In addition, by means of a contact surface for a sealing element, sealing can be improved and thus a secure and preferably fully sealing design can be provided. In addition, the sealing element can be arranged in a stable position in a mounted state, in particular surrounded by a sealing element receptacle and the contact surface. In particular, the recess has a thread corresponding to the screw plug, in particular internal thread, which is in particular a corresponding standard thread, in particular a corresponding standard internal thread. The screw plug can be screwed into and/or unscrewed from the recess along the internal threaded region by means of the threaded element. In a mounted state, the sealing element can at least partially and preferably completely adjoin the contact surface. The contact surface and the sealing element receptacle can at least partially and preferably completely surround the sealing element in the mounted state. In particular, the screw plug is screwed in the mounted state into the recess, specifically by means of the threaded element. Advantageously, the screw plug is connected at least in a force-fitting and/or form-fitting manner in the mounted state to the pump component. Preferably, the sealing element seals at least one region between the contact surface and the screw plug, in particular the sealing element receptacle.

Furthermore, it is proposed that the recess has a sunk region, which at least partially forms the contact surface. In particular, the sunk region at least partially receives the screw plug in the mounted state. In particular, the sunk region is realized as a levelly and/or flatly sunk region. In particular, a depression of the sunk region has a diameter which is larger than a diameter of the outer region of the base body. This allows a design to be further improved, specifically in respect of sealing. In addition, an advantageously space-saving installation of the screw plug can thereby be made possible and thus an outlay, in particular an installation outlay, can be reduced.

In addition, it is proposed that the tolerance compensation unit is configured to compensate manufacturing tolerances of at least one manufacturing dimension of the chamfer. For example, the chamfer could be made too large within a tolerance range, with the tolerance compensation unit compensating for said tolerance range. The tolerance compensation unit compensates the tolerance range in that the sealing element receptacle and thus, in particular, the sealing element are displaced radially outward by the tolerance compensation unit. This ensures sealing contact between a sealing element and a pump component despite a chamfer having been manufactured incorrectly, in particular to be too large, and thus a design can be advantageously improved. The sealing element is advantageously positioned on a larger diameter by the tolerance compensation unit.

In order to further improve a design, it is proposed that the tolerance compensation unit is configured to compensate tolerances regarding installation of the sealing element. For example, the sealing element could be incorrectly positioned during installation. The tolerance compensation unit compensates this in particular by pushing the sealing element into a correct position during screwing. This prevents a sealing element from slipping and/or jamming. Furthermore, sealing can thereby be improved.

Particularly advantageous properties in respect of a design, in particular in respect of sealing, can be achieved by a pump comprising at least one pump device.

Furthermore, a method for producing a pump device is proposed, comprising a screw plug which has a threaded element and a base body which is connected to the threaded element and has a sealing element receptacle, which circulates in the circumferential direction, for a sealing element, wherein, at least when viewed radially, a tolerance compensation unit is arranged between the threaded element and the sealing element receptacle. By means of such a production method, efficiency and design can be advantageously improved. The efficiency can be increased preferably in respect of product and/or labor and/or production and/or cost efficiency. Furthermore, owing to a tolerance compensation unit, tolerances, in particular manufacturing tolerances, specifically deviations in a material thickness of a screw plug and/or of a pump component, in particular of a recess into which the screw plug can be screwed and/or from which it can be unscrewed, are compensated and an outlay, in particular a production and/or installation outlay, is thus reduced and costs, in respect of material and/or installation and/or production costs, are lowered.

The pump device according to the invention and/or the pump are not intended to be limited here to the above-described application and embodiment. The pump device according to the invention and/or the pump may possibly have a number of individual elements, components and units differing from the number specified herein for fulfillment of a function described herein. In addition, for the value ranges specified in this document, values that are within the specified limits shall also be deemed to be disclosed and to be usable as desired.

### DRAWINGS

Further advantages are apparent from the description below of the drawings. The drawings illustrate an exemplary embodiment of the invention. The drawings, description and claims contain numerous features in combination. A person skilled in the art will expediently also consider the features individually and combine them into meaningful further combinations.

In the drawings:

FIG. 1 shows a pump comprising a pump device in a simplified cross-sectional illustration,

FIG. 2 shows a screw plug of the pump device in a simplified cross-sectional illustration,

FIG. 3 shows a detailed view of the screw plug with a base body and with a sealing element receptacle according to FIG. 2,

FIG. 4 shows the screw plug in a simplified top view,

FIG. 5 shows a sealing element of the pump device in a simplified cross-sectional illustration,

FIG. 6 shows a pump component of the pump with a recess in a simplified cross-sectional illustration,

FIG. 7 shows the screw plug in a mounted state in the recess in a simplified cross-sectional illustration,

FIG. 8 shows a detailed view of the screw plug with a tolerance compensation unit in the mounted state according to FIG. 7,

FIG. 9 shows a further detailed view of the screw plug with the tolerance compensation unit, and

FIG. 10 shows a flow diagram of a method for producing the pump device.

### DESCRIPTION OF THE EXEMPLARY EMBODIMENT

In the following, only one of the multiple objects in the figures is in each case provided with a reference sign. Furthermore, the present figures are schematic illustrations which are not true to scale.

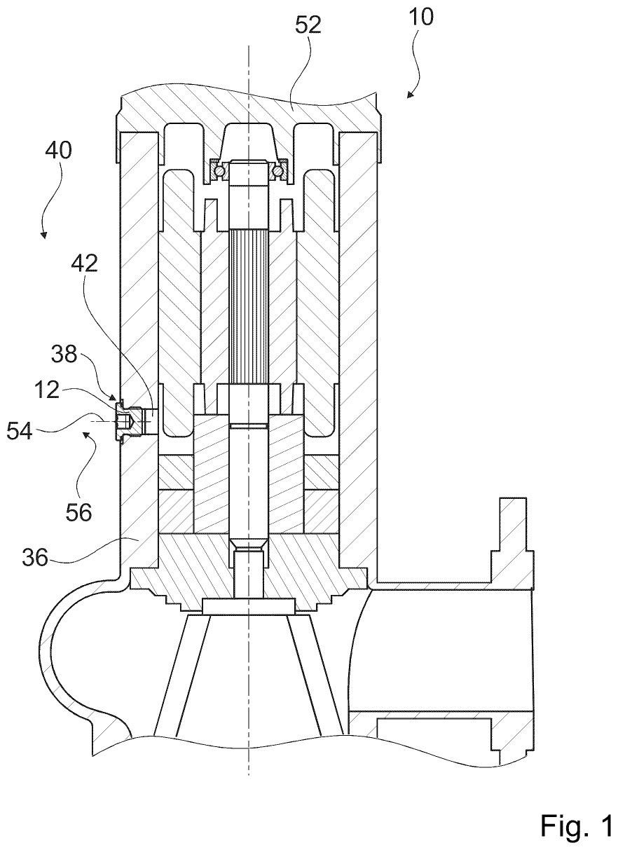

FIG. 1 shows a part of a pump 52 comprising a pump device 10 in a cross-sectional illustration. The pump device 10 has a screw plug 12. In particular, the precise implementation of the screw plug 12 could also differ in respect of a standard. A different intended use from the one illustrated here would also be conceivable.

In the present exemplary embodiment, the pump device 10 comprises a pump component 36 with a recess 38. The recess 38 is designed here as a service connection.

The recess 38 connects a first spatial region 40 to at least one second spatial region 42 fluid-technically and/or gas-technically. In the present exemplary embodiment, the recess 38, which is realized as a hole, connects an environment 56 of the pump 52 to an interior of the pump 52 (cf. FIG. 1). The recess 38 is configured for the fluid-tight and/or gas-tight sealing of the first spatial region 40 from the second spatial region 42 for receiving at least the screw plug 12.

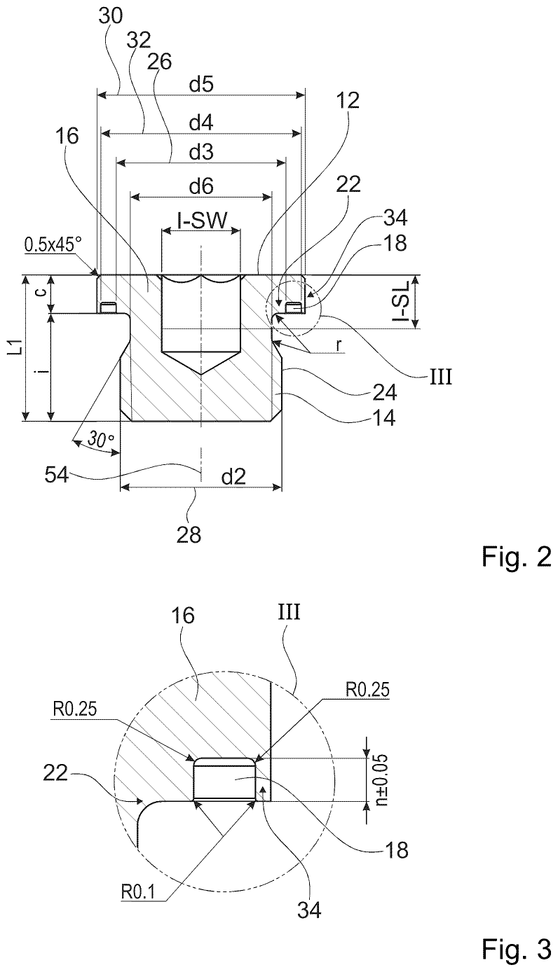

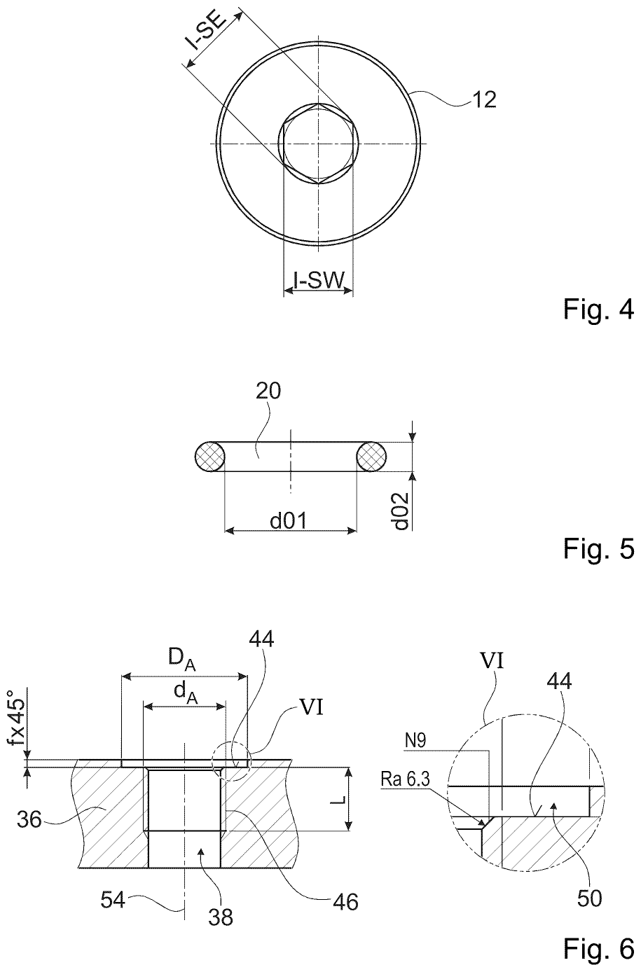

The screw plug 12 has a threaded element 14. In addition, the screw plug 12 has a base body 16 connected to the threaded element 14. The base body 16 connected to the threaded element 14 has a sealing element receptacle 18, which circulates in the circumferential direction, for a sealing element 20 (also see FIGS. 2 to 5). The sealing element 20 is illustrated separately in FIG. 5. In the present case, the sealing element 20 is embodied as an O-ring seal.

An inner diameter 26 of the sealing element receptacle 18 is substantially larger than a nominal diameter 28 of the threaded element 14. An outer diameter 30 of the base body 16 is substantially larger than an outer diameter 32 of the sealing element receptacle 18 (cf. FIG. 2).

The pump component 36 has a contact surface 44 for the sealing element 20, and the recess 38 has an internal threaded region 46 for the threaded element 14 and has a chamfer 48, which connects the contact surface 44 to the internal threaded region 46 (cf. by way of example FIGS. 8 and 9). The recess 38 has a sunk region 50 which at least partially forms the contact surface 44. The sunk region 50 is realized ed as a levelly sunk region. The contact surface 44 is oriented perpendicularly to a screw axis 54 (cf. FIGS. 8 and 9).

In the present exemplary embodiment, the screw plug 12 is formed from a rust-free material. In the present embodiment, the screw plug 12 is specifically formed from rust-free A4 stainless steel, preferably A4-70 stainless steel.

When viewed radially, a tolerance compensation unit 22 of the screw plug 12 is arranged between the threaded element 14 and the sealing element receptacle 18.

The tolerance compensation unit 22 is realized as a portion of the base body 16. The tolerance compensation unit 22 partially delimits the sealing element receptacle 18. The tolerance compensation unit 22 specifically delimits the sealing element receptacle 18 at least in the direction of the screw axis 54 of the screw plug 12. The tolerance compensation unit 22 extends circumferentially around the threaded element 14 perpendicularly to the threaded element 14 (cf. FIGS. 2, 3 and 7 to 9).

The threaded element 14 has a standard external thread 24. In the present exemplary embodiment, but not limited thereto, the threaded element 14 has a cylindrical Whitworth pipe thread according to standard DIN 259.

The base body 16 has an outer region 34 arranged outside the sealing element receptacle 18, as viewed radially. The outer region 34 partially delimits the sealing element receptacle 18. The outer region 34 specifically delimits the sealing element receptacle 18 in a direction facing away from the screw axis 54.

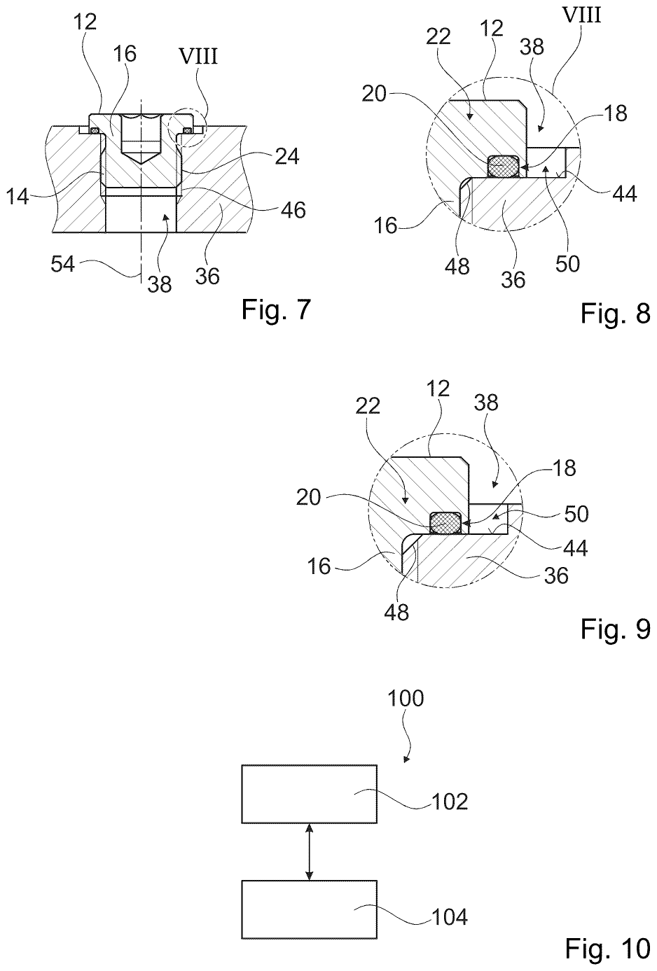

The tolerance compensation unit 22 is configured to compensate manufacturing tolerances of at least one manufacturing dimension of the chamfer 48 (cf. FIGS. 7 to 9). In addition, the tolerance compensation unit 22 is configured to compensate tolerances with regard to installation of the sealing element 20. The tolerance compensation unit 22 specifically ensures sealing contact of the sealing element 20 with the contact surface 44.

FIG. 9 shows, by way of example, a chamfer 48 manufactured too large. Even in the case of the chamfer 48 which is illustrated here by way of example and is manufactured too large, the tolerance compensation unit 22 ensures sealing contact of the sealing element 20 with the contact surface 44.

FIGS. 2 to 6 each illustrate dimensioned drawings of individual parts of the pump device 10, wherein FIGS. 2 to 5 illustrate dimensions of the screw plug 12 and of the sealing element 20. FIG. 6, on the other hand, illustrates a dimensioning of the recess 38 of the pump component 36. In the present exemplary embodiment, the screw plug 12 has a standard G1/2-inch thread. Since, however, further sizes of the screw plug 12 and of the recesses 38 corresponding to the screw plug 12 are, of course, conceivable, some of the dimensions in the dimensioned drawings have been replaced by corresponding placeholders, namely letter designations.

The following two tables (Tables 1 and 2) show dimensions for the screw plug 12 and the sealing element 20, specifically in accordance with a thread size and a collar size of the screw plug 12 (Table 1), and dimensions for the recess 38 of the pump component 36 (Table 2).

A few sizes are designated by way of example; d3 is the inner diameter 26 of the sealing element receptacle 18, d2 is the nominal diameter 28 of the threaded element 14, d4 is the outer diameter 32 of the sealing element receptacle 18, and d5 is the outer diameter 30 of the base body 16. It can be seen both from Table 1 and from FIG. 2 that the inner diameter 26 of the sealing element receptacle 18 is substantially larger than the nominal diameter 28 of the threaded element 14. Furthermore, the outer diameter 30 of the base body 16 is substantially larger than the outer diameter 32 of the sealing element receptacle 18.

Furthermore, d01 refers to an inner diameter of the sealing element 20 and d02 to a cord diameter of the sealing element 20 (cf. FIG. 5).

TABLE 1

| | | | | | | | | | | | | | | O-ring |
|---|---|---|---|---|---|---|---|---|---|---|---|---|---|---|
| | c | n | d3 | d4 | d5 | d6 | i | L1 | I-SW | I-SE | I-SL | r | | d02 × d01 |
| Size d2 | [mm] | [mm] | [mm] | [mm] | [mm] | [mm] | [mm] | [mm] | [mm] | [mm] | [mm] | [mm] | d3/d2 | [mm] |
| G ⅛″ | 4.0 | 1.4 | 10.0 | 14.0 | 15.0 | 8.2 | 11 | 15.0 | 5 | 5.8 | 4 | 0.5 | 1.03 | 1.8 × 10 |
| G ¼″ | 4.0 | 1.4 | 14.0 | 18.0 | 19.0 | 11 | 14 | 18.0 | 6 | 6.9 | 5 | 0.7 | 1.06 | 1.8 × 14 |
| G ½″ | 5.0 | 1.4 | 22.0 | 26.0 | 27.0 | 18 | 14 | 19.0 | 10 | 11.5 | 7 | 0.9 | 1.05 | 1.8 × 22 |
| G ¾″ | 5.0 | 1.5 | 28.0 | 33.0 | 34.0 | 23.5 | 16 | 21.0 | 12 | 13.9 | 9 | 0.9 | 1.06 | 2.0 × 28 |
| G 1″ | 6.0 | 1.5 | 35.0 | 40.0 | 42.0 | 29.3 | 16 | 22.0 | 17 | 19.6 | 9 | 1.2 | 1.05 | 2.0 × 35 |

TABLE 2

| | D_{A} min. | q | q max. | L min. | L (Ex) min. |
|---|---|---|---|---|---|
| d_{A} | [mm] | [mm] | [mm] | [mm] | [mm] |
| G ⅛″ | 18 | 1.0 | 1.0 | 10 | 14 |
| G ¼″ | 23 | 1.2 | 1.5 | 14 | 16 |
| G ½″ | 28 | 1.4 | 2.5 | 16 | — |
| G ¾″ | 35 | 1.4 | 2.5 | 18 | — |

Furthermore, FIG. 9 shows a flow diagram of a method 100 for producing a pump device 10. The method for producing the pump device 10 could comprise a plurality of method steps and/or partial method steps. In a first method step 102, the screw plug 12 which has the threaded element 14 and the base body 16 which is connected to the threaded element 14 and has the sealing element receptacle 18, which circulates in the circumferential direction, for the sealing element 20, is provided.

In a further method step 104, the tolerance compensation unit 22 is arranged, at least when viewed, between the threaded element 14 and the sealing element receptacle 18. Method step 102 and further method step 104 could be carried out in any sequence.

### REFERENCE SIGNS

10 Pump device
12 Screw plug
14 Threaded element
16 Base body
18 Sealing element receptacle
20 Sealing element
22 Tolerance compensation unit
24 Standard external thread
26 Inner diameter
28 Nominal diameter
30 Outer diameter (base body)
32 Outer diameter (sealing element receptacle)
34 Outer region
36 Pump component
38 Recess
40 First spatial region
42 Second spatial region
44 Contact surface
46 Internal threaded region
48 Chamfer
50 Sunk region
52 Pump
54 Screw axis
56 Environment
100 Method
102 Method step
104 Method step

1. A pump device comprising a screw plug comprising a threaded element and a base body which is connected to the threaded element, and comprising a sealing element receptacle, which circulates in a circumferential direction, for a sealing element, wherein, at least when viewed radially, a tolerance compensation unit is arranged between the threaded element and the sealing element receptacle.

2. The pump device as claimed in claim 1, wherein the tolerance compensation unit is realized as a portion of the base body and at least partially delimits the sealing element receptacle.

3. The pump device as claimed in claim 1, wherein the tolerance compensation unit extends circumferentially around the threaded element at least substantially perpendicularly to the threaded element.

4. The pump device as claimed in claim 1, wherein the threaded element has a standard external thread.

5. The pump device as claimed in claim 1, wherein an inner diameter of the sealing element receptacle is substantially larger than a nominal diameter of the threaded element.

6. The pump device as claimed in claim 1, wherein an outer diameter of the base body is substantially larger than an outer diameter of the sealing element receptacle.

7. The pump device as claimed in claim 1, wherein the base body has an outer region which, when viewed radially, is arranged outside the sealing element receptacle and at least partially delimits the sealing element receptacle.

8. The pump device as claimed in claim 1, comprising a pump component with a recess, in particular a service connection, which connects at least one first spatial region to at least one second spatial region fluid-technically and/or gas-technically, wherein the recess for fluid-tight and/or gas-tight sealing of the first spatial region against the second spatial region is configured for receiving at least the screw plug.

9. The pump device as claimed in claim 8, wherein the pump component has a contact surface for the sealing element, and the recess has an internal threaded region for the threaded element and has a chamfer which connects the contact surface to the internal threaded region.

10. The pump device as claimed in claim 9, wherein the recess has a sunk region, which at least partially forms the contact surface.

11. The pump device as claimed in claim 9, wherein the tolerance compensation unit is configured to compensate manufacturing tolerances of at least one manufacturing dimension of the chamfer.

12. The pump device as claimed in claim 1, wherein the tolerance compensation unit is configured to compensate tolerances regarding installation of the sealing element.

13. A pump comprising at least one pump device as claimed in claim 1.
